(19) United States
(12) Patent Application Publication
(10) Pub. No.: US 2007/0106047 A1
(43) Pub. Date: May 10, 2007

(54) Thermoplastic polyurethane containing polymer polyols

(76) Inventors: Hauke Malz, Diepholz (DE); Elke Berger, Senftenberg (DE); Bernd Zaschke, Schonfeld (DE); Sylvia Seibelt, Ostercappeln (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/581,043

(22) PCT Filed: Nov. 27, 2004
(86) PCT No.: PCT/EP04/13472

§ 371 Date: May 30, 2006

(30) Foreign Application Priority Data
Dec. 1, 2003 (DE) 10356612.0

(51) Int. Cl. C08G 18/00

(52) U.S. Cl. 528/44

(57) ABSTRACT

The invention relates to thermoplastic polyurethanes, obtainable by reacting polyisocyanates with chain extenders and polymer polyols, wherein the polymer polyol is prepared by using a difunctional polyether polyol having exclusively primary OH groups and a molecular weight of from 500 to 2000 as a carrier polyol.

The invention relates to thermoplastic polyurethanes (referred to hereinbelow as TPUs), obtainable by reacting polyisocyanates with chain extenders and polymer polyols, said polymer polyol being prepared using a difunctional polyether polyol having exclusively primary OH groups and a molecular weight of from 500 to 2000 as a carrier polyol.

Polymer polyols are disclosed by the prior art. DE-A-27 28 284 describes a polymer polyol preparation which is extremely stable and filterable and can be produced without alkyl mercaptan as a chain transfer agent (moderator).

Also known from DE-A-27 08 267 and DE-A-27 08 268 is the production of polyurethane elastomers for improving the release and demolding properties using a grafted polyol based on poly(oxypropylene)-poly(oxyethylene) glycol.

Thermoplastics are widely used in industry and find use in the form of sheets, films, moldings, bottles, sheaths, packaging and the like. Thermoplastic polyurethanes belong to the group of the segregated block copolymers, i.e. they consist of two polymer blocks joined together, or phases, known as the rigid phase and the flexible phase. TPUs are generally produced from an isocyanate, a chain extender and a preferably difunctional polyol. The amounts of polyol and chain extender on the one hand and isocyanate groups on the other hand are typically adjusted in such a way that the ratio of isocyanate to hydroxyl groups is approximately 1. The ratio of isocyanate group to hydroxyl group is also referred to as the index. An index of >1000 describes an isocyanate excess, an index of <1000 a hydroxyl group excess. Chain extenders and isocyanate in a TPU generally form the rigid phase, polyol and isocyanate the flexible phase.

TPUs have many chemical and mechanical properties which make them a suitable material for the abovementioned applications. For instance, TPUs are very flexible, have very high tear strength, high tensile strength, good tear propagation resistance, low attrition, good cold flexibility, good chemical resistance and good hydrolysis stability. Selective use of the starting components additionally allows these properties to be optimized for a certain desired application; TPUs are thus obtainable in a range from 80 Shore A to 74 Shore D. However, when the Shore hardness is raised, the glass transition temperature of the flexible phase simultaneously increases. This results in a decrease in the cold flexibility, which is undesired in a whole series of applications.

In the case of flexible TPUs, however, the material tends to block, i.e. granules can stick together, or else films and cables which are wound up can only be unwound again with very great difficulty. In order to reduce the adherence, matting concentrates are nowadays added to a sample. Matting concentrates are, for example, mixtures of TPU with a further polymer, for example polystyrene. However, this leads to the TPU film no longer being transparent, which is significant for many applications. In addition, the concentrate has to be mixed with the TPU before the processing, which constitutes a further working step. However, this is often not possible for manufacturing technology reasons. Frequently, films in which a further polymer has been blended with the TPU, for example via a matting concentrate, tend to stress whitening. Stress whitening means that the film has an irreversible white line at a crease. The avoidance of this visible damage is a decisive quality criterion.

It is thus an object of the invention to produce a TPU which, while retaining the typical TPU properties such as tensile strength; elongation at break, attrition and tear propagation resistance, additionally has improved cold flexibility, and does not block but is at the same time very transparent.

This object can be achieved by a thermoplastic polyurethane which is obtainable by reacting isocyanate with a special polymer polyol.

The invention thus provides a thermoplastic polyurethane, obtainable by reacting
a) isocyanates, preferably diisocyanates, with
b) chain extenders and
c) polymer polyols, said polymer polyol being prepared using a difunctional polyether polyol having exclusively primary OH groups and a molecular weight of from 500 to 2000 as a carrier polyol, and
d) if appropriate, polyols having a molecular weight of from 400 to 3000 g/mol and an average functionality of from 1.8 to 2.3.

Thermoplastic polyurethanes are polyurethanes which, when repeatedly heated and cooled in the temperature range typical for the processing and use of the material, remain thermoplastic. Thermoplastic refers in this context to the property of the polyurethane of softening repeatedly under hot conditions in a temperature range between 150 and 300° C. which is typical for the polyurethane, and hardening on cooling, and being repeatedly shapable in the softened state by flowing as a molding, extrudate or shaped part to give semifinished or finished articles.

The inventive thermoplastic polyurethanes are preferably contact-transparent. In this context, contact-transparent means that an inscription of letter size 3 (letter type arial) in the color black can be read clearly through a TPU plate of thickness more than 2 mm, preferably thickness more than 4 mm, especially preferably thickness more than 8 mm when the plate is directly on the inscription. This is also referred to as contact transparency.

To prepare the inventive TPUs, the organic isocyanates (a) used may be commonly known aliphatic, cycloaliphatic, araliphatic and/or aromatic isocyanates, preferably diisocyanates. Examples thereof are tri-, tetra-, penta-, hexa-, hepta- and/or octa-methylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methyl cyclohexane 2,4- and/or -2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, dimethyidiphenyl 3,3′-diisocyanate, diphenylethane 1,2-diisocyanate and/or phenylene diisocyanate or mixtures thereof. Preference is given to using 4,4′-MDI and HDI, in particular 4,4′-MDI.

The chain extenders (b) used may be commonly known aliphatic, araliphatic, aromatic and/or cycloaliphatic compounds having a molecular weight of from 50 to 399 g/mol, preferably from 6.0 to 350 g/mol. The chain extenders are preferably difunctional compounds. Examples thereof are diamines and/or alkanediols having from 2 to 10 carbon atoms in the alkylene radical, in particular 1,4-butanediol, 1,6-hexanediol and/or di-, tri-, tetra-, penta-, hexa-, hepta-, octa-, nona- and/or decaalkylene glycols having from 3 to 8 carbon atoms, preferably corresponding oligo- and/or polypropylene glycols, and mixtures of the chain extenders may also be used. Particular preference is given to using 1,4-butanediol.

The component (c) required for the preparation of the inventive TPUs is a polymer polyol, which are frequently also referred to as graft polyols. Polymer polyols are generally known and commercially available. Polymer polyols are prepared as a continuous phase by free-radical polymerization of the monomers, preferably acrylonitrile, styrene and also, if appropriate, further monomers, of a macromer, of a moderator, using a free-radical initiator, usually azo or peroxide compounds, in a polyetherol or polyesterol, frequently referred to as the carrier polyol. The examples of the preparation of polymer polyols which can be mentioned here are the patents U.S. Pat. No 4,568,705, U.S. Pat. No 5,830,944, EP 163188, EP 365986, EP 439755, EP 664306, EP 622384, EP 894812 and WO 00/59971.

Typically, this is an in situ polymerization of acrylonitrile, styrene or preferably mixtures of styrene and acrylonitrile, for example in a weight ratio of from 90:10 to 10:90, preferably from 70:30 to 30:70.

The carrier polyols used are compounds having at least a functionality of from 2 to 8, preferably from 2 to 6, and an average molecular weight of from 300 to 8000 g/mol, preferably from 300 to 5000 g/mol.

Macromers, also referred to as stabilizers, are linear or branched polyetherols having molecular weights of ≧1000 g/mol which comprise at least one terminal, reactive olefinic unsaturated group. The ethylenically unsaturated group may be added to an already existing polyol via reaction with carboxylic anhydrides such as maleic anhydride, fumaric acid, acrylate and methacrylate derivatives, and also isocyanate derivatives such as 3-isopropenyl-1,1-dimethylbenzyl isocyanate, isocyanatoethyl methacrylate. A further route is the preparation of a polyol by alkoxidation of propylene oxide and ethylene oxide using starter molecules having hydroxyl groups and an ethylenic unsaturation. Examples of such macromers are described in the patents U.S. Pat. No 4,390,645, U.S. Pat. No 5,364,906, EP 0461800, U.S. Pat. No 4,997,857, U.S. Pat. No. 5,358,984, U.S. Pat. No. 5,990,232, WO 01/04178 and U.S. Pat. No 6,013,731.

During the free-radical polymerization, the macromers are incorporated into the copolymer chain. This forms block copolymers having a polyether block and a poly(acrylonitrile-styrene) block, which function as compatibilizers in the interface of continuous phase and dispersed phase, and suppress the agglomeration of the polymer polyol particles. The proportion of the macromers is typically from 1 to 15% by weight, preferably from 3 to 10% by weight, based on the total weight of the monomers used to prepare the polymer polyol.

To prepare polymer polyols, moderators, also known as chain transferrers, are typically used. The moderators reduce the molecular weight of the copolymer forming by chain transfer of the growing radical, which reduces the crosslinking between the polymer molecules, which influences the viscosity and the dispersion stability, and also the filterability of the polymer polyols. The proportion of the moderators is typically from 0.5 to 25% by weight, based on the total weight of the monomers used to prepare the polymer polyol. Moderators which are typically used to prepare the polymer polyols are alcohols such as 1-butanol, 2-butanol, isopropanol, ethanol, methanol, cyclohexane, toluene, mercaptans such as ethanethiol, 1-heptanethiol, 2-octanethiol, 1-dodecane-thiol, thiophenol, 2-ethylhexyl thioglycolates, methyl thioglycolates, cyclohexyl mercaptan and also enol ether compounds, morpholine and α-(benzoyloxy)styrene. Preference is given to using alkyl mercaptan.

To initiate the free-radical polymerization, it is customary to use peroxide or azo compounds such as dibenzoyl peroxide, lauroyl peroxide, t-amylperoxy 2-ethyl-hexanoate, di-t-butyl peroxide, diisopropyl peroxide carbonate, t-butylperoxy 2-ethyl-hexanoate, t-butyl perpivalate, t-butyl perneodecanoate, t-butyl perbenzoate, t-butyl percrotonate, t-butyl perisobutyrate, t-butylperoxy 1-methylpropanoate, t-butylperoxy 2-ethylpentanoate, t-butylperoxy octanoate and di-t-butyl perphthalate, 2,2′-azobis(2,4-dimethylvaleronitrile), 2,2′-azobisisobutyronitrile (AIBN), dimethyl 2,2′-azobisisobutyrate, 2,2′-azobis(2-methylbutyronitrile) (AMBN), 1,1′-azobis(1-cyclo-hexanecarbonitrile). The proportion of the initiators is typically from 0.1 to 6% by weight, based on the total weight of the monomers used to prepare the polymer polyol.

The free-radical polymerization to prepare the polymer polyols is, owing to the reaction rate of the monomers and the half-life of the initiators, typically carried out at temperatures of from 70 to 150° C. and a pressure up to 20 bar. Preferred reaction conditions for preparing polymer polyols are temperatures of from 80 to 140° C. at a pressure of from atmospheric pressure to 15 bar.

Polymer polyols are prepared in continuous processes, using stirred tanks having continuous feed and discharge, stirred tank batteries, tubular reactors and loop reactors having continuous feed and discharge, or in batchwise processes, by means of a batch reactor or of a semibatch reactor.

The polymer polyols may be used alone or else in a mixture with a component (d) comprising polyols having a number-average molecular weight of from 400 to 3000 g/mol, preferably from 500 to 1500 g/mol, and an average functionality of from 1.8 to 2.3, preferably from 1.9 to 2.1, more preferably of 2.0.

It is an essential feature of the present invention that the polymer polyol (c) is prepared using a difunctional polyetherpolyol having exclusively primary OH groups and a number-average molecular weight of from 500 to 2000 g/mol, preferably from 750 to 1500 g/mol, more preferably from 800 to 1200 g/mol, as a carrier polyol.

In a preferred embodiment, the polymer polyol (c) is prepared using polytetrahydro-furan (PTHF), typically having a number-average molecular weight of from 500 to 2000 g/mol, preferably from 750 to 1500 g/mol, more preferably from 800 to 1200 g/mol, in particular of about 1000 g/mol, as the carrier polyol.

Suitable olefinic monomers for the preparation of the solids content of the polymer polyol are, for example, styrene, acrylonitrile, acrylates and/or acrylamide. In a preferred embodiment, the olefinic monomers used are acrylonitrile, styrene, especially styrene and acrylonitrile in a ratio between 1:1 and 3:1. Preference is also given to adding a macromer to the polymerization. If appropriate, the polymerization is also carried out using a moderator and using a free-radical initiator.

In a preferred embodiment, the solids content comprises acrylonitrile, styrene and macromer, the proportion of acrylonitrile being from 10 to 50% by weight and preferably from 25 to 35% by weight, the proportion of styrene from 30 to 90% by weight, preferably from 55 to 70% by weight, and the proportion of macromer from 1 to 10% by weight, preferably from 3 to 6% by weight, based on the total weight of the solids content of the polymer polyol (c).

In a preferred embodiment, the polymer polyol (c) has a solids content of from 20 to 50% by weight, preferably from 25 to 45% by weight, more preferably from 30 to 40% by weight, based on the total weight of the polymer polyol.

The polyols (d) are preferably polyether polyols having a functionality of 1.8-2.3, preferably 1.9-2.1, in particular of 2. Particular preference is given to using poly-THF, especially having a number-average molecular weight of about 1000 g/mol.

In addition to the components a) to d), the components e) to g) may also be added to the inventive thermoplastic polyurethanes. These components may either already be added to the reaction of a) to d), or added to the resulting polyurethane.

As component e), catalysts may be used. Suitable catalysts accelerate the reaction between the NCO groups of the isocyanates (a) and the hydroxyl groups of the polyol components (b), (c) and, if appropriate, (d). These are generally customary compounds disclosed by the prior art, for example tertiary amines of organic metal compounds such as titanic esters, iron compounds, e.g. iron(III) acetylacetonate, tin compounds, e.g. tin dioctoate or tin dilaurate. The catalysts may be used individually or in combination and are typically used in amounts of from 0.0001 to 0.1 part by weight per 100 parts by weight of the total weight of components (b), (c) and, if appropriate, (d). Particular preference is given to using tin dioctoate as a catalyst.

As component f, stabilizers may be used. Stabilizers are substances which comprise an active ingredient group which protects a polymer or a polymer mixture from harmful environmental influences. Examples of harmful environmental influences are thermal oxidation, damage by UV radiation, damage by ozone, nitrous gases, acidic gases and acidic precipitation, atmospheric moisture. As a consequence of the importance for the quality of a polymer, very many stabilizers have become commercially available and a review is given in Plastics Additives Handbook, 5^{th} edition, H. Zweifel, ed., Hanser Publishers, Munich, 2001 ([1]), pp. 98-136.

As component f), phenolic antioxidants in particular are used. Examples of phenolic antioxidants are given in Plastics Additives Handbook, 5^{th} edition, H. Zweifel, ed., Hanser Publishers, Munich, 2001, pp. 98-107 and pp. 116-121.

Preference is given to those phenolic antioxidants whose molecular weight is greater than 700 g/mol. An example of a phenolic antioxidant used with preference is pentaerythrityl tetrakis(3-(3,5-bis(1,1-dimethylethyl)-4-hydroxyphenyl)propionate) (Irganox® 1010). The phenolic antioxidants are generally used in concentrations of from 0.1 to 5% by weight, preferably 0.1-2% by weight, in particular 0.5-1.5% by weight.

When the inventive TPU is exposed to ultraviolet radiation, stabilization comprising only phenolic stabilizers is often inadequate. For this reason, the inventive TPUs that are exposed to UV light are preferably additionally stabilized with a UV absorbent. UV absorbents are molecules that absorb energy-rich UV light and dissipate the energy. Common UV absorbents which find use in industry belong, for example, to the group of the cinnamic esters, the diphenyl cyanoacrylates, the formamidines, the benzylidene malonates, the diarylbutadienes, triazines and the benzotriazoles. Examples of commercial UV absorbents can be found in Plastics Additives Handbook, 5^{th} edition, H. Zweifel, ed., Hanser Publishers, Munich, 2001, pages 116-122.

In a preferred embodiment, the UV absorbents have a number-average molecular weight of greater than 300 g/mol, in particular greater than 390 g/mol. In addition, the UV absorbents used with preference should have a molecular weight of not greater than 5000 g/mol, more preferably of not greater than 2000 g/mol.

Particularly suitable as UV absorbents is the group of the benzotriazoles. Examples of particularly suitable benzotriazoles are Tinuvin® 213, Tinuvin® 328, Tinuvin® 571 and Tinuvin®384. Typically, the UV absorbents are added in amounts of from 0.01 to 5% by weight based on the overall TPU composition, preferably from 0.1 to 2.0% by weight, in particular from 0.3 to 0.75% by weight.

An above-described UV stabilization based on an antioxidant and a UV absorbent is often inadequate to ensure good stability of the inventive TPU against the harmful influence of UV rays. In this case, a hindered amine light stabilizer (HALS) may preferably also be added to the component f), in addition to the antioxidant and the UV absorbent, to the inventive TPU. The activity of the HALS compounds is based on their ability to form nitroxyl radicals which intervene in the mechanism of the oxidation of polymers. HALS are regarded as highly efficient UV stabilizers for most polymers.

HALS compounds are commonly known and commercially available. Examples of commercially available HALS stabilizers can be found in Plastics Additives Handbook, 5th edition, H. Zweifel, Hanser Publishers, Munich, 2001, p. 123-136.

The hindered amine light stabilizers selected are preferably hindered amine light stabilizers whose number-average molecular weight is greater than 500 g/mol. In addition, the molecular weight of the preferred HALS compounds should not be greater than 10 000 g/mol, more preferably not greater than 5000 g/mol.

Particularly preferred hindered amine light stabilizers are bis(1,2,2,6,6-pentamethyl-piperidyl)sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). Special preference is given to the condensation product of 1-hydroxy-ethyl-2,2,6,6-tetramethyl-4-hydroxypiperidine and succinic acid (Tinuvin® 622) when the titanium content of the product is <150 ppm, preferably <50 ppm, especially preferably <10 ppm.

As component g), further additives may be used which are added to the inventive TPU in order to “tailor” certain properties. These include processing assistants; nucleating agents, plasticizers.

In the development of the formulation for an inventive TPU, the procedure is generally as follows. A fixed amount of isocyanate a) (Xᵢₛₒ in g) is taken. This lays down the stoichiometric amount of isocyanate (Nᵢₛₒ)
(Nᵢₛₒ=Xᵢₛₒ/Mᵢₛₒ) [equation 1]
Mᵢₛₒ=molecular weight of isocyanate in g/mol
Nᵢₛₒ=amount of isocyanate in moles

The ratio of polyol components (polyol d)+polymer polyol c)) to chain extender determines the hardness of the TPU. To set the hardness of the TPU, the chain extender b) and the polyol component may be varied within relatively wide molar ratios. It has been found that useful molar ratios of the polyol component to total amount of chain extenders (b) to be used are from 10:1 to 1 :10, in particular from 1:1 to 4:1, and the hardness of the TPU rises with increasing content of chain extender. How much chain extender is required to achieve a certain Shore hardness is well known to those skilled in the art, but can otherwise be determined rapidly by a few experiments. When the amount of chain extender required (X_{ce} in g) has been determined, the stoichiometric amount of chain extender is calculated from:
N_{ce}=X_{ce}/M_{ce} [equation 2]
M_{ce}=molar mass of chain extender in g/mol
N_{ce}=amount of chain extender in moles

The stoichiometric amount N_{PO} of polyol component then accordingly follows the equation:
N_{PO}=Nᵢₛₒ−N_{ce} [equation 3]

N_{PO} is composed of the two stoichiometric amounts of polymer polyol component c) (N_{POC}) and polyol component d) (N_{POD}).
N_{PO}=N_{POC}+N_{POD} [equation 4]

Depending on how high the solids content of polymer particles in the TPU is now to be, the stoichiometric amount of polyol component d) and polymer polyol component c) may be varied. Multiplication of N_{POC} and N_{POD} by the respective molecular weights M_{POC} and M_{POD} then gives the amount of the polyol d) and polymer polyol c) to be used respectively.

Since a polymer polyol is de facto not a pure substance having a defined molar mass, but rather a mixture of two polymers, the procedure in determining the molar mass M_{PoD} is, for the sake of simplicity, to determine the OH number of the polymer polyol c) and then to calculate a theoretical molecular weight from the OH number.
M_{POD}=56100*2/OH number [equation 5]

The calculations detailed above apply strictly only to TPU having an index of 1000, i.e. the ratio of isocyanate to polyol is 1. Where an index not equal to 1000 is to be used, the amount of isocyanate Xᵢₛₒ is multiplied by index/1000 and an amount of isocyanate (X′ᵢₛₒ) thus determined. This amount of isocyanate is then used for the experiments. It is customary to work in the TPU production with indices between 600 and 1200, preferably 900-1100.

It has been found that, surprisingly, the mechanical properties of the inventive TPU are distinctly better at an index greater than 1000 than at indices below 1000. Particular preference is therefore given to working with an index of 1005-1050, in particular 1005-1025.

The invention also provides a process for producing thermoplastic polyurethane by reacting
a) isocyanates, preferably diisocyanates, with
b) chain extenders and
c) polymer polyols, said polymer polyol being prepared using a difunctional polyether polyol having exclusively primary OH groups and a molecular weight of from 500 to 2000 as a carrier polyol, and
d) if appropriate, a polyol having a molecular weight of from 400 to 3000 g/mol and an average functionality of from 1.8 to 2.3, preferably from 1.9 to 2.1, in particular of 2.

For preferred embodiments of the components used in the process according to the invention, the remarks made above on the inventive TPU apply.

The inventive TPUs are preferably produced continuously, for example using reaction extruders or the belt process by one-shot or the prepolymer process. Alternatively, the process may also proceed batchwise by the known prepolymer process.

In extruder processes, the structural components (a), (b), (c), and also, if appropriate, (d), (e), (f) and/or (g) are introduced into the extruder individually or as a mixture, reacted, for example, at temperatures of from 100 to 280° C., preferably from 140 to 250° C., and the resulting TPU is extruded, cooled and granulated.

When the inventive TPUs are prepared in the laboratory, the procedure is typically to heat the polyol component, i.e. the polymer polyol c) and, if appropriate, the polyol d) together with the chain extender b) to approx. 85° C. in a tinplate bucket. When the temperature has been attained, if appropriate, catalysts e), additives f and further assistants g) are metered in and homogenized. Afterward, the isocyanate a) is added with stirring. The onset of the polyaddition reaction causes the temperature in the reaction vessel to rise. At 110° C., the contents of the tinplate bucket are poured into a flat Teflon dish which is heated at approx. 125° C. for approx. 10 min. Finally, the thus produced slab is stored at 80° C. for 15 h. After granulation, the thus produced inventive TPU can be further processed by customary processes.

It has been found that, surprisingly, the inventive TPU is contact-transparent when the coefficient K_{b} of the refractive indices of a TPU of the same base formulation without polymer particles and the molar-weighted adduct of the refractive indices of the homopolymers of the polymer polymer is between 0.99 and 1.01, preferably between 0.995 and 1.005.

The invention further provides the use of inventive contact-transparent TPUs for producing films and fibers. Moreover, it finds use for automobile applications in the interior such as upholstery and covering materials, dashboards or airbags, or for applications in the automobile exterior sector in tires, shock absorbers or protective strips. It also finds use for cable sheaths, casings, shoe soles, dispersions, coatings or paints.

The inventive TPU preferably finds use as a film, for example as a cover film for skis, as a cable sheath, as an injection molding, for example as a ski boot and/or as a sieve.

The invention thus also provides a ski comprising the inventive thermoplastic polyurethanes. The invention further provides a ski boot comprising the inventive thermoplastic polyurethanes.

The invention is to be illustrated by examples which follow.

### EXAMPLES

Preparation of the polymer polyol which is used in examples 1 to 9:

The polymer polyol was prepared by the semibatch seed process.

a) Preparation of the Seed:

357.12 g of a polyoxypropylene-polyoxyethylene glycol as a carrier polyol together with 23.81 g of a macromer (propoxylated fumaric monoester of a glycerol-started polyoxypropylene polyoxyethylene glycol) were introduced in a 2 l autoclave having stirrer, internal cooling coils and electrical heating mantle, and inertized. Subsequently, the pressure was increased with the aid of nitrogen to an elevated pressure of 1 bar and the mixture was heated to the synthesis temperature of 125° C. The remaining portion of the reaction mixture, consisting of further carrier polyol, V 601 initiator (from Wako Chemicals GmbH), the acrylonitrile/styrene monomers in a ratio of 1:2 and the 1-dodecanethiol reaction moderator, were initially charged in two metering vessels. The polymer polyols were synthesized by transferring the raw materials from the metering vessels at constant metering rate via a static inline mixer into the reactor. The metering time for the monomer-moderator mixture (209.98 g of acrylonitrile, 420.02 g of styrene, 6.62 g of 1-dodecanethiol) was 150 minutes, while the polyol-initiator mixture (379.52 g of carrier polyol) was metered into the reactor over 165 minutes. After a further 10 minutes-of continued reaction time at reaction temperature, the crude polymer polyol was transferred via the bottom discharge valve into a glass flask. Subsequently, the product was freed of the unconverted monomers and other volatile compounds at a temperature of 135° C. under reduced pressure (<0.1 mbar). The end product was finally stabilized with 500 ppm of Irganox® 1135 (from CIBA Spezialitätenchemie Lampertsheim GmbH).

The seed had a viscosity of 5170 mPa·s at a solids content of 45.76%

b) Preparation of the End Polymer Polyol

This was by the same procedure as the seed preparation. In addition to 428.59 g of polytetrahydrofuran and 18.52 g of macromer, 132.57 g of the seed from a) were initially charged in the reactor and heated to 125° C. A mixture of 163.32 g of acrylonitrile, 326.68 g of styrene and 5.15 g of 1-dodecanethiol was metered in within 150 min and, in parallel over 165 min, a mixture of 455.46 g of polytetrahydrofuran and 2.28 g of V 601 initiator. After removal of the unconverted monomers and volatile compounds and also stabilization with 500 ppm of Irganox 1135 a viscosity of 3558 mPa·s of the finished polymer polyol was determined at a solids content of 35.94%.

### Example 1

Example 1 describes the preparation of a TPU in a hand-casting process. The polymer polyol of the experimental series has an OH number of 71.8 and a solids content of 37%.

### Example 1.1

TPU of Shore hardness 85 A without polymer particles

In this example, the base formulation of the experimental series is described. Experiments belong to a base formulation when the reactants are the same and the ratio of isocyanate (e.g. 4,4′-MDI) to chain extender (e.g. 1,4-butanediol) is identical.

921.27 of PTHF 1000 were heated to approx. 90° C. in a tinplate bucket. Subsequently, 8.08 g of Irganox® 1010 and 8.08 g of Irganox® 1098, and also 117.68 g of butanediol were added with stirring. The solution was heated to 80° C. with stirring. Subsequently, 572.27 g of 4,4′-MDI were added and the solution was stirred until it was homogeneous. Afterward, the TPU was poured into a flat dish and initially heated at 125° C. on a hotplate for 10 min, then in a heating cabinet at 110° C. for 15 h.

### Example 1.2

TPU of the base formulation from example 1.1 with 5% polymer content 739.01 g of PTHF 1000 and 216.22 g of polymer polyol were heated to approx. 90° C. in a tinplate bucket. Subsequently, 8.08 g of Irganox® 1010 and 8.08 g of Irganox® 1098 and also 111.79 g of butanediol were added with stirring. The solution was heated to 80° C. with stirring. Subsequently, 543.64 g9of 4,4′-MDI were added and the solution was stirred until it was homogeneous. Afterward, the TPU was poured into a flat dish and initially heated on a hotplate at 125° C. for 10 min, then in a heating cabinet at 110° C. for 15 h.

### Example 1.3

TPU of the base formulation from example 1.1 with 10% polymer content 556.74 g of PTHF 1000 and 432.43 g of polymer polyol were heated to approx. 90° C. in a tinplate bucket. Subsequently, 8.08 g of Irganox® 1010, 8.08 g of Irganox® 1098, 10 μl of tin dioctoate solution (5% in dioctyl adipate) and also 105.91 g of butanediol were added with stirring. The solution was heated to 80° C. with stirring. Subsequently, 515.02 g of 4,4′-MDI were added and the solution was stirred until it was homogeneous. Afterward, the TPU was-poured into a flat dish and initially heated on a hotplate at 125° C. for 10 min, then in a heating cabinet at 110° C. for 15 h.

### Example 1.4

TPU of the base formulation from example 1.1 with 15% polymer content 374.48 g of PTHF 1 000 and 648.65 g of polymer polyol were heated to approx. 90° C. in a tinplate bucket. Subsequently, 8.08 g of Irganox® 1010, 8.08 g of Irganox® 1098, 16 μl of tin dioctoate solution (5% in dioctyl adipate) and also 100.02 g of butanediol were added with stirring. The solution was heated to 80° C. with stirring. Subsequently, 486.39 g of 4,4′-MDI were added and the solution was stirred until it was homogeneous. Afterward, the TPU was poured into a flat dish and initially heated on a hotplate at 125° C. for 10 min, then in a heating cabinet at 110° C. for 15 h.

### Example 1.5

TPU of the base formulation from example 1.1 with 20% polymer content 192.22 g of PTHF 1000 and 864.86 g of polymer polyol were heated to approx. 90° C. in a tinplate bucket. Subsequently, 8.08 g of Irganox® 1010, 8.08 g of Irganox® 1098, 16 μl of tin dioctoate solution (5% in dioctyl adipate) and also 94.13 g of butanediol were added with stirring. The solution was heated to 80° C. with stirring. Subsequently, 457.76 g of 4,4′-MDI were added and the solution was stirred until it was homogeneous. Afterward, the TPU was poured into a flat dish and initially heated on a hotplate at 125° C. for 10 min, then in a heating cabinet at 110° C. for 15 h.

### Example 1.6

TPU of the base formulation from example 1.1 with 25% polymer content 9.95 g of PTHF 1000 and 1081.08 g of polymer polyol were heated to approx. 90° C. in a tinplate bucket. Subsequently, 8.08 g of Irganox® 1010, 8.08 g of Irganox® 1098, 16 μl of tin dioctoate solution (5% in dioctyl adipate) and also 88.25 g of butanediol were added with stirring. The solution was heated to 80° C. with stirring. Subsequently, 429.13 g of 4,4′-MDI were added and the solution was stirred until it was homogeneous. Afterward, the TPU was poured into a flat dish and initially heated on a hotplate at 125° C. for 10 min, then in a heating cabinet at 110° C. for 15 h.

TABLE 1

| | Example | Example | Example | Example | Example | Example |
|---|---|---|---|---|---|---|
| Base formulation 1 | 1.1 | 1.2 | 1.3 | 1.4 | 1.5 | 1.6 |
| Density (g/cm³) | 1.119 | 1.117 | 1.115 | 1.113 | 1.110 | 1.109 |
| Shore hardness A | 88 | 89 | 90 | 92 | 94 | 94 |
| Shore hardness D | 41 | 45 | 47 | 51 | 55 | 56 |
| Tensile strength | 46 | 55 | 54 | 48 | 42 | 47 |
| (MPa) | | | | | | |
| Elongation at break | 420 | 480 | 460 | 440 | 410 | 450 |
| (%) | | | | | | |
| Tear propagation | 45 | 58 | 50 | 58 | 66 | 76 |
| resistance (N/mm) | | | | | | |
| Attrition (mm³) | 35 | 33 | 38 | 41 | 48 | 47 |

### Example 2

Example 2 describes the production of a TPU film

The TPUs described in example 1 were ground in a mill having an 8 mm sieve. The granules were processed at 220° C. on a BRABENDER Plasti Corder having a flat-film die (100 mm); A film thickness of 150 μm was set.

In each case 2 4 cm×10 cm sections of the films prepared in this way were placed one on top of the other and compressed for 4 h at 80° C. with a weight of 1 kg. This resulted in adherence of the films. Subsequently, the films joined together in this way were pulled apart again using a tensile testing machine (Zwick Z010). The forces arising in this process are a direct measure of the tendency of the films to block. As can be seen from table 2, the inventive films block less than the corresponding film without polymer particles.

TABLE 2

| Specimen | Polymer content (solids) | Tear propagation resistance |
|---|---|---|
| 1.1 | 0% | 4 N/cm |
| 1.3 | 10% | 2.8 N/cm |
| 1.5 | 20% | 2.0 N/cm |

### Example 3

Films according to example 2 are swelled by immersing in the plasticizer Benzoflex® XP 4030 (Velsicol, USA) for 1 week. Subsequently, the weight increase is measured. The weight increase is a direct measure of how compatible the plasticizer is in the TPU. The greater the uptake, the greater the compatibility. As can be seen from table 3, the plasticizer uptake is better for a TPU comprising polymer polyol than for a TPU of the base formulation.

TABLE 3

| Film | TPU | Polymer content (solids) | Weight increase in % (absolute) |
|---|---|---|---|
| 2.1 | 1.1 | 0% | 58 |
| 2.3 | 1.3 | 10% | 73 |
| 2.5 | 1.5 | 20% | 94 |

### Example 4

TPU from example 1.5 was processed in a similar manner to example 2 to give films of thickness 200 μm. To improve the UV stability, a batch of 2% of a UV-protection concentrate (conc. 2877, Elastogran GmbH) was metered in. The films were illuminated to ISO 4982-2 with a black panel temperature of 100° C. for 100 h. Subsequently, the Yellowness Index (YI) was determined in reflection. It can be seen from table 4 that the inventive TPU can be protected with UV-protection concentrates.

TABLE 4

| Specimen | Conc. 2877 | YI after 100 h |
|---|---|---|
| 4.1 | — | 63 |
| 4.2 | 2% | 17 |

### Example 5

Example 5 describes the preparation of a TPU in a hand-casting process. The index used was 1020. The polymer polyol of the experimental series has an OH number of 68.7 and a solids content of 36.46%.

### Example 5.1

TPU of Shore hardness 54 D without polymer particles

This example describes the base formulation of the experimental series. The experiments belong to one base formulation when the reactants are the same and the ratio of isocyanate (e.g. 4,4′-MDI) to chain extender (e.g. 1,4-butanediol) is identical.

535.84 g of PTHF 1000 (OHN 113.8) and 166.31 g of butanediol were heated to approximately 85° C. in a tinplate bucket. Subsequently, 6.63 g of Irganox® 1010 and 6.63 g of Irganox® 1098 were added with stirring. Subsequently, 609.81 g of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

### Example 5.2

TPU of base formulation 5.1 with 10% polymer content

262.34 g of PTHF 1000 (OHN 113.8), 356.56 g of polymer polyol and 148.23 g of butanediol were heated to approximately 90° C. in a tinplate bucket. Subsequently, 6.62 9 of Irganox® 1010 and 6.62 g of Irganox® 1098 were added with stirring. Subsequently, 543.52.g of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

### Example 5.3

TPU of base formulation 5.1 with 19% polymer content

16.20 g of PTHF 1000 (OHN 113.8), 677.45 g of polymer polyol and 131.96 g of butanediol were heated to approximately 90° C. in a tinplate bucket. Subsequently, 6.62 g of Irganox® 1010 and 6.62 g of Irganox® 1098 were added with stirring. Subsequently, 483.87 g of 4,4′-MDI were added at 80° C. The solution was stirred until it was homogeneous. Afterward, the TPU was poured into a flat dish and heated initially on a hotplate at 125° C. for 10 min, then in a heating cabinet at 1 10° C. for 15 h.

### Example 6

Example 6 describes the preparation of a TPU in a hand-casting process. The index used was 1020. The polymer polyol of the experimental series has an OH number of 68.7 and a solids content of 36.46%.

### Example 6.1

This example describes the base formulation of the experimental series. The experiments belong to one base formulation when the reactants are the same and the ratio of isocyanate (e.g. 4,4′-MDI) and chain extender (e.g. 1,4-butanediol) is identical.

481.20 g of PTHF 1000 (OHN 113.8) and 184.45 g of butanediol were heated to approximately 85° C. in a tinplate bucket. Subsequently, 6.63 g of Irganox® 1010 and 6.63 g of Irganox® 1098 were added with stirring. Subsequently, 647.04 g of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

### Example 6.2

TPU of base formulation 6.1 with 7.5% polymer content

280.53 g of PTHF 1000 (OHN. 113.8), 267.42 g of polymer polyol (OHN 68.7; solids content: 36.46%) and 169.41 g of butanediol were heated to approximately 90° C. in a tinplate bucket. Subsequently, 6.62 9 of Irganox® 1010 and 6.62 g of Irganox® 1098 were added with stirring. Subsequently, 594.29 g of 4,4′-MDI were added at 80° C. The solution was stirred until it was homogeneous. Afterward, the TPU was poured into a flat dish and heated initially on a hotplate at 125° C. for. 10 min, then in a heating cabinet at 110° C. for 15 h.

### Example 6.3

TPU of base formulation 6.1 with 17% polymer content

26.35 9 of PTHF 1000 (OHN 113.8), 606.14 g of polymer polyol (OHN 68.7; solids content: 36.46%) and 150.37 9 of butanediol were heated to approximately 90° C. in a tinplate bucket. Subsequently, 6.62 9 of Irganox® 1010 and 6.62 9 of Irganox® 1098 were added with stirring. Subsequently, 527.48 9 of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

### Example 7

Example 7 describes tensile impact tests to DIN EN ISO 179/2. The raw data were filtered using a 2nd order low-pass Butterworth filter with a limiting frequency of 4 kHz. The recognition of complete fracture was after a force decrease to 1% of the maximum. It can be seen from table 6 that the inventive polymer polyol has better cold flexibility than a comparable TPU without polymer polyol content.

TABLE 6

| | Solids content in % | Shore | |
|---|---|---|---|
| Example | by weight | hardness | Fracture temperature ° C. |
| 5.1 | 0 | 62 | −25.0 |
| 5.2 | 10 | 65 | −20.0 |
| 5.3 | 19 | 68 | −18.5 |
| 6.1 | 0 | 68 | −10.0 |
| 6.2 | 7.5 | 70 | −10.0 |
| 6.3 | 17 | 72 | −10.0 |

### Example 8

Example 8 describes the preparation of a TPU in a hand-casting process. The index was varied. The polymer polyol of the experimental series has an OH number of 74.65 and a solids content of 33.35%. The solids content of polymer particles in the TPU is 13%.

### Example 8.1

### Index 1000

24.29 g of PTHF 1000 (OHN 113.8), 584.71 g of polymer polyol (OHN 74.65; solids content: 33.35%) and 208.50 g of butanediol were heated to approximately 90° C. in a tinplate bucket. Subsequently, 7.58 g of Irganox® 1010 and 7.58 g of Irganox® 1098 were added with stirring. Subsequently, 682.51 g of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

### Example 8.2

### Index 1010

24.29 g of PTHF 1000 (OHN 113.8), 584.71 g of polymer polyol (OHN 74.65; solids content: 33.35%) and 208.50 g of butanediol were heated to approximately 90° C. in a tinplate bucket. Subsequently, 7.61 g of Irganox® 1010 and 7.61 9 of Irganox® 1098 were added with stirring. Subsequently, 689.33 g of 4,4′-MDI were added at 80° C. The solution was stirred until it was homogeneous. Afterward, the TPU was poured into a flat dish and heated initially on a hotplate at 125° C. for 10.min, then in a heating cabinet at 110° C. for 15 h.

### Example 8.3

### Index 1020

24.29 g of PTHF 1000 (OHN 113.8), 584.71 g of polymer polyol (OHN 74.65; solids content: 33.35%) and 208.50 g of butanediol were heated to approximately 90° C. in a tinplate bucket. Subsequently, 7.65 g of Irganox® 1010 and 7.65 g of Irganox® 1098 were added with stirring. Subsequently, 696.16 g of 4,4′-MDI were added at 80° C. The solution was stirred until it was homogeneous. Afterward, the TPU was poured into a flat dish and heated initially on a hotplate at 125° C. for 10 min, then in a heating cabinet at 110° C. for 15 h.

Table 7 shows that the attrition at an index of >1000 is less than in the case of index 1000

TABLE 7

| Experiment | Index | Attrition |
|---|---|---|
| 8.1 | 1000 | 61 |
| 8.2 | 1010 | 55 |
| 8.3 | 1020 | 55 |

### Example 9

The inventive TPU from example 8.2 was injection-molded to a slab of thickness 2 mm. The slab is contact-transparent, i.e. an inscription of point size 3 (letter type arial) can be read through the slab. Even in the case of 4 slabs layered one on top of the other, the inscription is legible.

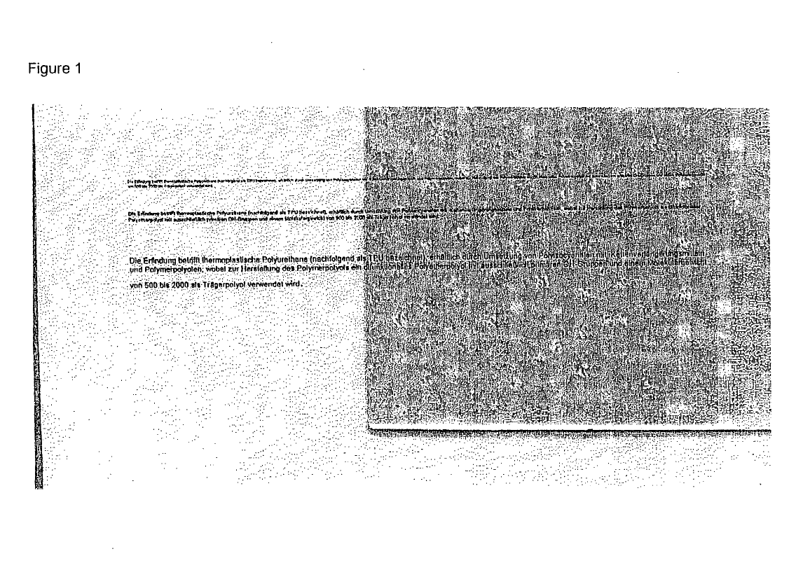

FIG. 1 shows a text of point size 3, 4 and 6 (letter type arial) which has been scanned through the TPU slab (Hewlett Packard ScanJet ADF, true color mode). The inscription can be scanned legibly through the slab.

1. A thermoplastic polyurethane, obtained by reacting
a) at least one isocyanate with
b) at least one chain extender and
c) at least one polymer polyol, said at least one polymer polyol being prepared using, and comprising, at least one carrier polyol, wherein the at least one carrier polyol comprises a difunctional polyether polyol having exclusively primary OH groups and a molecular weight of from 500 to 2000 and
d) optionally, at least one polyol having a molecular weight of from 400 to 3000 g/mol and an average functionality of from 1.8 to 2.3.

2. The thermoplastic polyurethane according to claim 1, wherein, in (c), the at least one carrier polyol is polytetrahydrofuran.

3. The thermoplastic polyurethane according to claim 1, wherein the at least one polymer polyol (c) comprises a solids content, wherein said solids content comprises acrylonitrile, styrene and at least one macromer, and wherein the proportion of acrylonitrile in the solids content is from 10 to 50% by weight, wherein the proportion of styrene in the solids content is from 30 to 90% by weight and the proportion of the at least one macromer is from 1 to 10% by weight, based on the total weight of the solids content of the at least one polymer polyol (c).

4. The thermoplastic polyurethane according to claim 3, wherein the at least one polymer polyol (c) comprises a solids content of from 20 to 50% by weight, based on the total weight of the at least one polymer polyol.

5. The thermoplastic polyurethane according to claim 1, wherein the at least one polymer polyol (c) is used in an amount of from 30 to 75% by weight, based on the total weight of the thermoplastic polyurethane.

6. The thermoplastic polyurethane according to claim 1, wherein the reacting is carried out at an isocyanate index of from 1005 to 1025.

7. The thermoplastic polyurethane according to claim 1, which is contact-transparent.

8. A process for producing a thermoplastic polyurethane comprising reacting
a) at least one isocyanate with
b) at least one chain extender and
c) at least one polymer polyol, said at least one polymer polyol being prepared using, and comprising, at least one carrier polyol, wherein the at least one carrier polyol comprises a difunctional polyether polyol having exclusively primary OH groups and a molecular weight of from 500 to 2000, and
d) optionally, at least one polyol having a molecular weight of from 400 to 3000 g/mol and an average functionality of from 1.8 to 2.3.

9. A method of forming a film, a cable sheath, or an injection molding comprising forming the film, the cable sheath, or the injection molding with the thermoplastic polyurethane of claim 1.

10. A ski comprising the thermoplastic polyurethane according to claim 1.

11. The thermoplastic polyurethane of claim 1, wherein the reacting comprises (d) at least one polyol having a molecular weight of from 400 to 3000 g/mol and an average functionality of from 1.8 to 2.3.

12. The process of claim 8, wherein the process comprises (d) at least one polyol having a molecular weight of from 400 to 3000 g/mol and an average functionality of from 1.8 to 2.3

13. The thermoplastic polyurethane according to claim 2, wherein the at least one polymer polyol (c) is used in an amount of from 30 to 75% by weight, based on the total weight of the thermoplastic polyurethane.

14. The thermoplastic polyurethane according to claim 3, wherein the at least one polymer polyol (c) is used in an amount of from 30 to 75% by weight, based on the total weight of the thermoplastic polyurethane.

15. The thermoplastic polyurethane according to claim 4, wherein the at least one polymer polyol (c) is used in an amount of from 30 to 75% by weight, based on the total weight of the thermoplastic polyurethane.

16. The thermoplastic polyurethane according to claim 2, wherein the reacting is carried out at an isocyanate index of from 1005 to 1025.

17. The thermoplastic polyurethane according to claim 3, wherein the reacting is carried out at an isocyanate index of from 1005 to 1025.

18. The thermoplastic polyurethane according to claim 4, wherein the reacting is carried out at an isocyanate index of from 1005 to 1025.

19. The thermoplastic polyurethane according to claim 5, wherein the reacting is carried out at an isocyanate index of from 1005 to 1025.

20. The thermoplastic polyurethane according to claim 2, which is contact-transparent.
